(19) United States
(12) Patent Application Publication
(10) Pub. No.: US 2007/0242812 A1
(43) Pub. Date: Oct. 18, 2007

(54) Apparatus and system for operating a community

(75) Inventor: Arie Ben Harush, Hanegev (IL)

Correspondence Address: Kevin D. McCarthy;Roach Brown McCarthy & Gruber, P.C., 1620 Liberty Building, 420 Main Street, Buffalo, NY, 14202, US

(73) Assignee: Kidkool (2005) Ltd.

(21) Appl. No.: 11/800,682

(22) Filed: May 7, 2007

Related U.S. Application Data
(63) Continuation-in-part of application No. PCT/IL05/01152, filed on Nov. 3, 2005.

(30) Foreign Application Priority Data
Nov. 8, 2004 (IL) 165099

(51) Int. Cl. H04M 11/00

(52) U.S. Cl. 379/93.09

(57) ABSTRACT

A system for performing selective voice-over-IP (VOIP) communication by members of a community over a wide area network (WAN), that comprises a VOIP server, which routes voice-over-IP packets from one user to one or more other users; means provided within the VOIP server, or coupled to it, to maintain a list of members of the community; means provided within the VOIP server, or coupled to it, to determine which members of the community are available on-line at any given time and to notify other members of the community that the members are, or have become, available on-line, or have gone off-line; two or more users connected to a WAN via a PC, who are provided with VOIP communication devices; resident software provided in the PC of each of the members, to receive information from the VOIP server regarding the identity of members being or coming on-line, or going off-line; resident software provided in the PC of each of the members, to activate or deactivate a presence indicator, available to the user of the PC, which is indicative of the presence of one or more community members on-line; and VOIP communication apparatus, provided with each community member, suitable to permit voice-over-IP communication of a WAN.

### CLAIM OF PRIORITY

This application claims priority to international application No. PCT/IL2005/001152 filed on Nov. 3, 2005 which claims priority to Israeli patent application number 165099 filed on Nov. 8, 2004.

### FIELD OF THE INVENTION

The present invention relates to the field of multi-user voice-over-IP (VOIP) communication. More particularly the invention relates to a system and apparatus by means of which a VOIP community can be created, which exploits multi-cast communication.

### BACKGROUND OF THE INVENTION

Voice over IP is a well known method, by which the Internet Protocol is used to transmit voice from one Internet user to another. Various means and devices are commercially available, which make it possible to communicate using VOIP. These include, for instance, VOIP telephone devices, which a user can connect to his PC, e.g., via a USB port, and can use to transmit voice over the Internet using the Internet connection of his PC. The term “PC”, as used herein, refers to any terminal means that can be used to connect to the Internet, without limitation, and includes, for instance, PDAs, cellular phones with Internet capabilities, remote terminals, TV sets, etc.

It has now been found, and this is an object of the invention, that there is a very convenient and effective way to exploit VOIP and VOIP-enabled devices, in order to provide efficient, convenient and cost-effective communication within a predetermined community, when the community members are not obliged to coordinate the communication among them (although they may do so).

The term “community”, as used herein, is meant to indicate any group of persons or PCs, sharing a common relationship or interest. For instance, members of a family, calls mates, workers in the same workplace or within the same organization operating from different workplaces, all define different communities. The members of the community may be physically located at any location, in different or the same countries and at any distance between them, and their actual location is not a limiting factor.

It is therefore a purpose of the invention to provide a method and system, which will facilitate communication among members of a community.

It is another object of the invention to provide a method and a system which will permit a member of a community to selectively communicate with one or more other members of the same community.

It is yet another object of the invention to provide an apparatus that can be used to communicate between a plurality of members of a community.

Other purposes and advantages of the invention will become apparent as the description proceeds.

### SUMMARY OF THE INVENTION

In one aspect the invention is directed to a system for performing selective voice-over-IP (VOIP) communication by members of a community over a wide area network (WAN), comprising:
at least one VOIP server, which routes voice-over-IP packets from one user to one or more other users;
means provided within said VOIP server, or coupled to it, to maintain a list of members of the community;
means provided within said VOIP server, or coupled to it, to determine which members of the community are available on-line at any given time and to notify other members of the community that said members are, or have become, available on-line, or have gone off-line;
two or more users connected to a WAN via a PC, said users being provided with VOIP communication devices;
resident software provided in the PC of each of said members, to receive information from the VOIP server regarding the identity of members being or coming on-line, or going off-line;
resident software provided in the PC of each of said members, to activate or deactivate a presence indicator, available to the user of said PC, which is indicative of the presence of one or more community members on-line;
VOIP communication apparatus, provided with each community member, suitable to permit voice-over-IP communication of a WAN.

According to a preferred embodiment of the invention the WAN is the Internet. Preferably—but not limitatively—the means for maintaining a list of members of the community comprises a look-up table.

According to a preferred embodiment of the invention the means for determining which members of the community are available on-line at any given time and for notifying other members of the community that said members are, or have become, available on-line, or have gone off-line comprise a signal generated by a resident software.

According to another preferred embodiment of the invention the means for determining which members of the community are available on-line at any given time and for notifying other members of the community that said members are, or have become, available on-line, or have gone off-line comprise a response to an interrogation signal generated by the VOIP server.

The VOIP communication apparatus can be connected to the PC via a port, such as a USB port, or can be connected to the PC via wireless communication means, such as BlueTooth, WiFi or WiMAX.

The invention also encompasses a VOIP communication apparatus comprising a plurality of indicators, coupled to a plurality of buttons or switches, wherein each indicator is representative of the absence or presence of a member of a community on-line and wherein each button is suitable to permit voice-over-IP communication between said communication apparatus and the communication apparatus of the community member whose presence on-line is indicated by said indicator.

Also encompassed by the invention is a method for performing selective voice-over-IP (VOIP) communication by members of a community over a wide area network (WAN), comprising:
providing at least one VOIP server, suitable to route voice-over-IP packets from one user to one or more other users;
providing means within said VOIP server, or coupled to it, suitable to maintain a list of members of the community;
providing means within said VOIP server, or coupled to it, suitable to determine which members of the community are available on-line at any given time and to notify other members of the community that said members are, or have become, available on-line, or have gone off-line;
providing two or more users connected to a WAN via a PC, said users being provided with VOIP communication devices;
providing resident software in the PC of each of said members, suitable to receive information from the VOIP server regarding the identity of members being or coming on-line, or going off-line;
providing resident software in the PC of each of said members, suitable to activate or deactivate a presence indicator, available to the user of said PC, which is indicative of the presence of one or more community members on-line;
providing VOIP communication apparatus available to each community member, suitable to permit voice-over-IP communication of a WAN.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 schematically illustrates a communication device, according to a preferred embodiment of the invention; and

FIG. 2 schematically illustrates a system according to a preferred embodiment of the invention, only two members of the community being shown, for the sake of simplicity.

### DETAILED DESCRIPTION OF PREFERRED EMBODIMENTS

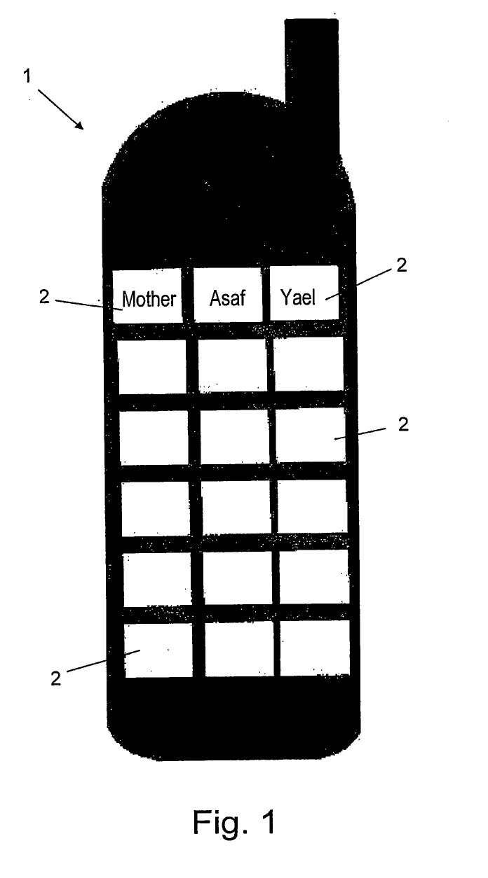

FIG. 1 schematically shows a communication device 1, similar to a wireless telephone, which is provided with a plurality of buttons 2. The buttons can be of the type that can become illuminated (i.e., containing a LED or similar lighting device), or may be coupled with a separate light (not shown in the figure).

Device 1 may be connected to a PC directly, i.e., via a USB port, or indirectly. For instance, Device 1 may be a wireless telephonic device, connected to a wireless base (not shown), which, in turn, may be connected through a wire connection or wirelessly to a port of a PC. All the means for achieving the wireless communication and the wire connections, to and from a PC and within the communication devices, e.g., BlueTooth, WiFi (a term for certain types of wireless local area network that use specifications in any 802.11 standard. The 802.11 specifications are part of an evolving set of wireless network standards known as the 802.11 family) or WiMAX (a wireless industry coalition whose members organized to advance IEEE 802.16 standards for broadband wireless access networks, for multimedia applications with wireless connections), are well known in the art and therefore are not discussed herein, for the sake of brevity.

Setting up the system of the invention is very simple and a typical installation will be described hereinafter, it being understood that the installation process described hereinafter is a non-limitative example.

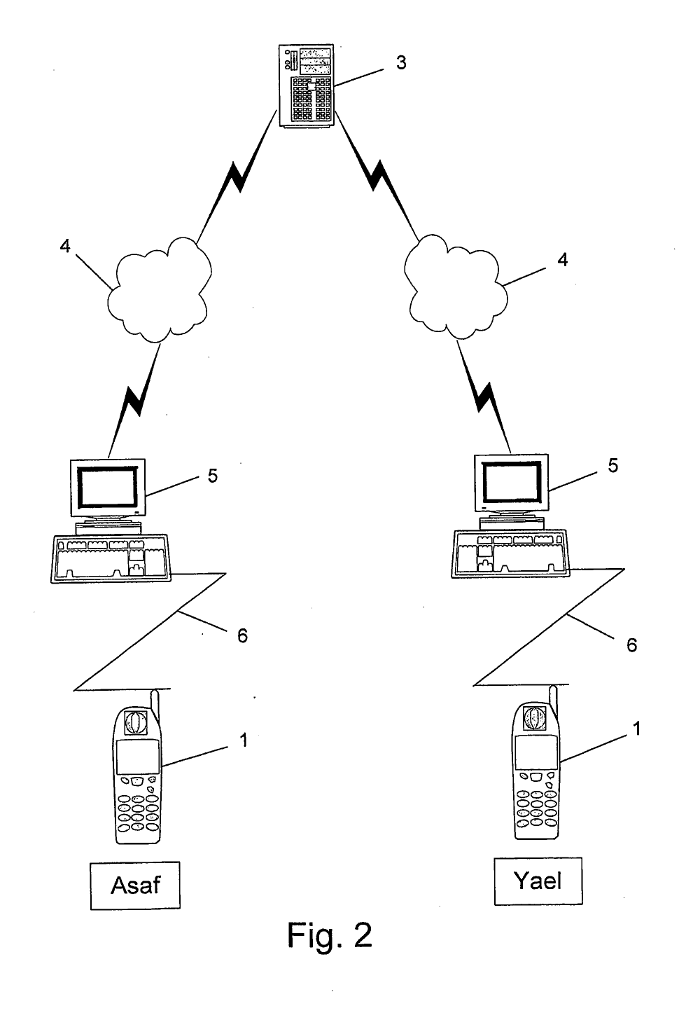

First, a software agent is installed in the PC, which, either by itself or in communication with VOIP server 3 of FIG. 2 (or other server) assigns a unique ID to the PC (and, thereby, to the user of the telephone). Then, the buttons 2 of the telephone device 1 (FIG. 1) are assigned IDs of members of the community with which the user wishes to communicate. This can be done in a variety of ways. For instance, if the user knows the ID of a community member, he may enter it either in an appropriate table via the PC keyboard, or directly in the telephone device. Alternatively, he may obtain a table of all IDs of a given community from the VOIP server 3, or from another source, and then he may select which ID, belonging to which member of his community, he wishes to assign to a specific button.

After the above set-up procedure is completed, the telephone device 1 is ready to communicate with all members of the community the IDs of whom have been assigned to its buttons.

When the system is in operation and the user of device 1 connects to the Internet via his PC, buttons 2 corresponding to members of the community who are currently on-line (i.e., who are currently connected to the Internet and whose corresponding communication device 1 is connected to their PC, light up, in a way that will be described hereinafter. The user can then connect to one or, simultaneously, to a plurality of the other members of the community, by pushing the lighted buttons that represent them. In FIG. 1 only three buttons have been named (Mother, Assaf, Yael) but, of course, as many buttons as desired can be attributed to different members of the community. Similarly, there is no practical limit to the number of buttons that can be provided, so that communities of different sizes can be accommodated, but, of course, the size of the device 1 will be dictated by the number of buttons that have to be housed and, when a large number of buttons is desired, a hand-held device may be impractical and a tabletop device should be employed.

Turning now to FIG. 2, the system that permits the communication among the members of a community is schematically shown. The system comprises one VOIP server 3, which stores details of the community members and, if available, their IP addresses. The IP addresses can be obtained on a case by case basis and are not a necessity to operate the system. A plurality of VOIP servers can of course be provided (not shown) for redundancy and quality of service purposes, as will be apparent to a skilled person but only one operational server is needed to operate the system.

The VOIP server fulfills two main purposes: Firstly, it routes the packets that carry the voice over IP from one member of the community to the other over the Internet (indicated by numeral 4) and, secondly, but very importantly, it alerts members of the community of the identity of other members currently on line. This is effected by means of a resident software in the PC, 5, of each user, which delivers a presence signal to the VOIP server when the PC connects to the Internet, which signal contain an identification of the member from whose PC it originates. The VOIP server thus is notified that a specific member is on-line, and of its IP address (whether it is a fixed address or an address assigned on a connection-by-connection basis by the ISP).

The VOIP server maintains a table of all members, showing their current status (on-line or off-line). When a member changes his status from off-line to on-line, the VOIP server broadcasts to the IP addresses of all other on-line members a signal identifying that that additional member is now on-line. The resident software of each PC receives the signal and actuates the light of button 2 (FIG. 1), turning it on. In that way the user of device 1 is alerted that a new member is now on-line and he may take one of the following actions: 1) he may push the button and initiate a private communication between him and the new member; 2) he may “join” the new member into a multi-user conversation, or 3) he may ignore the new member and not communicate with him. Communication between the PC's resident software and the communication device 1 is effected via a line 6, which may be wireless or wired.

Similarly, when a member goes off-line, the VOIP server broadcasts a notification to that effect and the resident software in each PC turns the light associated with that user's button off. The VOIP server may become alerted of the fact that a user is no longer on line in a plurality of ways, all well understood by the skilled person. For instance, the resident software of that user's PC may send a “sign-off” signal to the server, or the server may keep a presence check of all users on line (such as a Round Robin check), by sending a signal that requires response and marking a user as “off-line” is that signal is not responded to, or the activity of that user's PC can be checked and considered “off-line” when no activity is found for a predetermined period of time. The skilled person may, of course, devise additional ways to determine when a user has gone off-line.

When a community member connects to the Internet (or other WAN) all members who are already on-line receive a notification that he has become available for VOIP communication. The new joining member, on the other hand, will receive from the VOIP server signals representative of the presence of all the members who are already on-line. In other words, according to a preferred embodiment of the invention, at log-on the newly joining user may see that a plurality of lights become lighted on his communication device and he will then be able to select the lighted button(s) of the member(s) with whom he wishes to communicate.

As will be apparent from the above description, the method and system of the invention permit to create a very effective means of communication within a community, which allows members of that community to decide when and with whom they wish to communicate, among the available (on-line) members. The method is extremely simple to exploit and this is a substantial advantage with communities in which the members are young children or are not computer-savvy, such as old people or impaired persons.

All the above description has been provided for the purpose of illustration, and is not intended to limit the invention in any way. Various modifications can be carried out in the method and system according to the invention, without departing from its spirit.

1. A system for performing selective voice-over-IP (VOIP) communication by members of a community over a wide area network (WAN), comprising:
at least one VOIP server, which routes voice-over-IP packets from one user to one or more other users;
means provided within said VOIP server, or coupled to it, to maintain a list of members of the community;
means provided within said VOIP server, or coupled to it, to determine which members of the community are available on-line at any given time and to notify other members of the community that said members are, or have become, available on-line, or have gone off-line;
two or more users connected to a WAN via a PC, said users being provided with VOIP communication devices;
resident software provided in the PC of each of said members, to receive information from the VOIP server regarding the identity of members being or coming on-line, or going off-line;
resident software provided in the PC of each of said members, to activate or deactivate a presence indicator, available to the user of said PC, which is indicative of the presence of one or more community members on-line; and
VOIP communication apparatus, provided with each community member, suitable to permit voice-over-IP communication of a WAN.

2. A system according to claim 1, wherein the WAN is the Internet.

3. A system according to claim 1, wherein the means for maintaining a list of members of the community comprise a look-up table.

4. A system according to claim 1, wherein the means for determining which members of the community are available on-line at any given time and for notifying other members of the community that said members are, or have become, available on-line, or have gone off-line comprise a signal generated by a resident software.

5. A system according to claim 1, wherein the means for determining which members of the community are available on-line at any given time and for notifying other members of the community that said members are, or have become, available on-line, or have gone off-line comprise a response to an interrogation signal generated by the VOIP server.

6. A system according to claim 1, wherein the VOIP communication apparatus is connected to the PC via a port.

7. A system according to claim 6, wherein the port is a USB port.

8. A system according to claim 1, wherein the VOIP communication apparatus is connected to the PC via wireless communication means.

9. A VOIP communication apparatus comprising a plurality of indicators, coupled to a plurality of buttons or switches, wherein each indicator is representative of the absence or presence of a member of a community on-line and wherein each button is suitable to permit voice-over-IP communication between said communication apparatus and the communication apparatus of the community member whose presence on-line is indicated by said indicator.

10. A method for performing selective voice-over-IP (VOIP) communication by members of a community over a wide area network (WAN), comprising:
providing at least one VOIP server, suitable to route voice-over-IP packets from one user to one or more other users;
providing means within said VOIP server, or coupled to it, suitable to maintain a list of members of the community;
providing means within said VOIP server, or coupled to it, suitable to determine which members of the community are available on-line at any given time and to notify other members of the community that said members are, or have become, available on-line, or have gone off-line;
providing two or more users connected to a WAN via a PC, said users being provided with VOIP communication devices;
providing resident software in the PC of each of said members, suitable to receive information from the VOIP server regarding the identity of members being or coming on-line, or going off-line;
providing resident software in the PC of each of said members, suitable to activate or deactivate a presence indicator, available to the user of said PC, which is indicative of the presence of one or more community members on-line;
providing VOIP communication apparatus available to each community member, suitable to permit voice-over-IP communication of a WAN.

11. A method according to claim 10, wherein the WAN is the Internet.

12. A method according to claim 10, wherein the means for maintaining a list of members of the community comprise a look-up table.

13. A method according to claim 10, wherein the means for determining which members of the community are available on-line at any given time and for notifying other members of the community that said members are, or have become, available on-line, or have gone off-line comprise a signal generated by a resident software.

14. A method according to claim 10, wherein the means for determining which members of the community are available on-line at any given time and for notifying other members of the community that said members are, or have become, available on-line, or have gone off-line comprise a response to an interrogation signal generated by the VOIP server.

15. A method according to claim 10, wherein the VOIP communication apparatus is connected to the PC via a port.

16. A method according to claim 15, wherein the port is a USB port.

17. A method according to claim 10, wherein the VOIP communication apparatus is connected to the PC via wireless communication means.

18. A system according to claim 8, wherein the wireless communication means are selected from the following group:
BlueTooth;
WiFi; and
WiMAX;

19. A method according to any one of claim 18, wherein the wireless communication means are selected from the following group:
BlueTooth;
WiFi; and
WiMAX;
